(19) United States
(12) Patent Application Publication
(10) Pub. No.: US 2015/0044351 A1
(43) Pub. Date: Feb. 12, 2015

(54) METHODS AND COMPOSITIONS FOR MILKSHAKE PREPARATION

(71) Applicant: ENODIS CORPORATION, New Port Richey, FL (US)

(72) Inventors: Honor Luiz BRANDAO, Wesley Chapel, FL (US); Sheri NOORDHOF, Mount Pleasant, MI (US); Alison CULLIN, New Port Richey, FL (US); Kim MILLER-BOIVIN, New Port Richey, FL (US); Ryan BARLOW, Tampa, FL (US)

(21) Appl. No.: 14/454,597

(22) Filed: Aug. 7, 2014

Related U.S. Application Data
(60) Provisional application No. 61/863,349, filed on Aug. 7, 2013.

(51) Int. Cl. A23C 9/154; A23C 9/156

(52) U.S. Cl. CPC A23C 9/1544; A23C 9/156
USPC 426/584; 426/580

(57) ABSTRACT

The method and dairy base formulation allow a user to prepare a milkshake in more consistent ways, more quickly, and with lower cost than currently available formulations and methods. The dairy base formulation eliminates the need to prepare and store frozen dairy products such as ice cream beforehand. A milkshake can be prepared by blending ice, the dairy base formulation, and a flavor. The resulting milkshake has desirable organoleptic properties.

### CROSS-REFERENCE TO RELATED APPLICATIONS

The present application claims priority to U.S. Provisional Application No. 61/863,349, filed on Aug. 7, 2013, which is herein incorporated by reference.

### BACKGROUND OF THE DISCLOSURE

1. Field of the Disclosure

The present disclosure relates to methods and compositions for the preparation of milkshake beverages. More particularly, the present disclosure relates to methods and compositions for the preparation of milkshakes that do not require the preparation of ice cream or a frozen phase separately.

2. Description of the Related Art

Many retail establishments, such as quick service restaurants and convenience stores, as well as other food service establishments (e.g., schools or cafeterias) have a need to serve a convenient yet desirable frozen dairy drink. Traditionally, milkshakes are prepared by combining ice cream with milk and/or water, and mixing to the desired consistency. However, this process can be expensive, cumbersome, and time-consuming, since it requires the preparation of ice cream beforehand. It may also require manual labor on the part of the server.

Accordingly, there is a need to provide a desirable frozen product that is low-cost, and easy to prepare and serve.

### SUMMARY OF THE DISCLOSURE

The methods and compositions of the present disclosure address these concerns. Advantageously, the milkshakes of the present disclosure are prepared with ice or water, a dairy base formulation, and any desired additional flavors. These components can be mixed to prepare the milkshake without the time-consuming steps of preparing the ice cream first and then adding the ice cream to a vessel with other ingredients to prepare the milkshake.

In one embodiment, the present disclosure provides a method of preparing a milkshake, comprising the steps of: adding ice, a liquid dairy base, and a flavoring to a vessel, thereby forming a pre-milkshake mixture, and blending the pre-milkshake mixture, thereby forming the milkshake. The dairy base can comprise water, a milk solid, milk fat or vegetable fat, and at least one additive selected from the group consisting or a freezing point depressant, a sweetener, a mix of stabilizers and/or emulsifiers, and a shelf life stabilizer.

In another embodiment, the present disclosure provides a dairy base formulation, comprising water, a milk solid, milk fat or vegetable fat, and at least one additive selected from the group consisting or a freezing point depressant, a sweetener, a mix of stabilizers and/or emulsifiers, and a shelf life stabilizer.

### BRIEF DESCRIPTION OF THE DRAWINGS

FIG. 1 shows a flow chart depicting the process steps of making a milkshake according to the present disclosure; and

FIG. 2 shows a flow chart depicting the process steps for preparing the dairy base mix of the present disclosure.

FIG. 3 shows a schematic drawing of a machine of the present disclosure.

### DETAILED DESCRIPTION OF THE DISCLOSURE

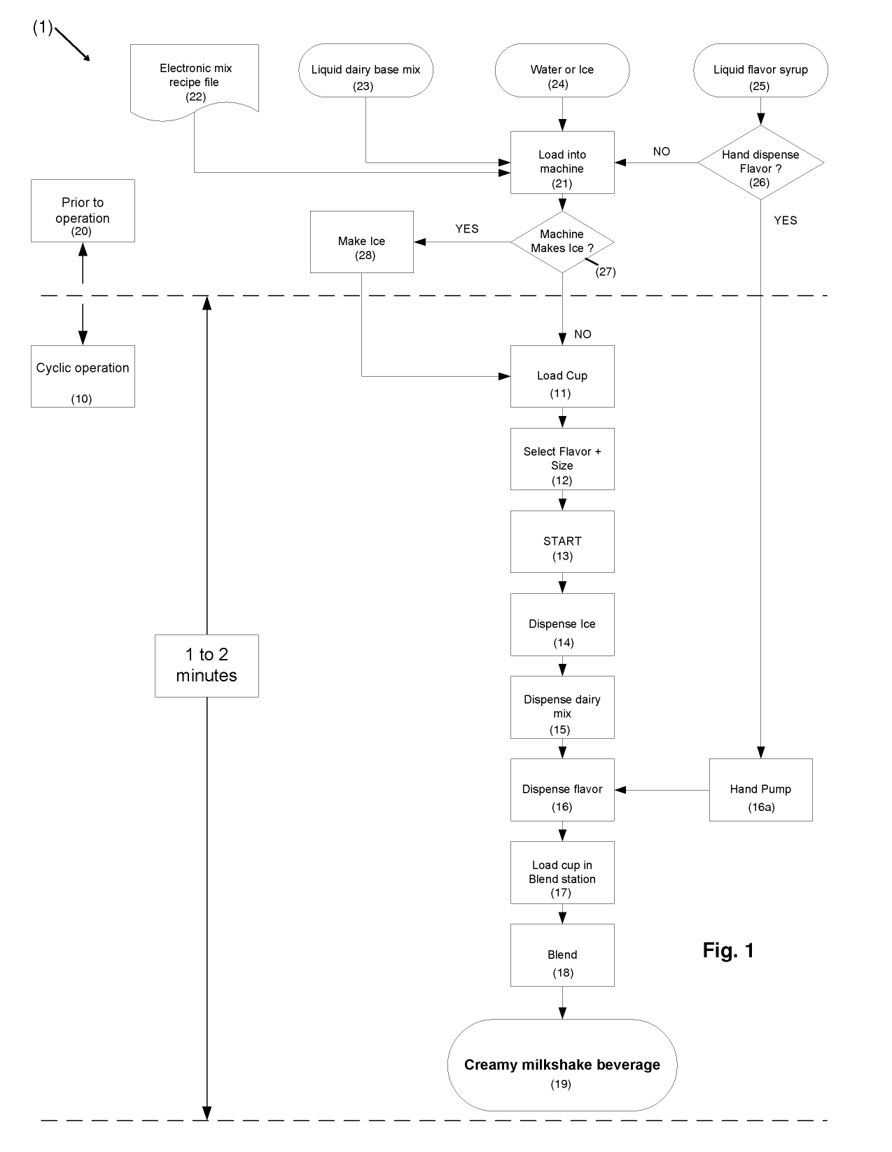

Referring to FIG. 1, a flow chart depicting the method of preparing the milkshakes of the present disclosure is shown. As used in the present disclosure, and for ease of description, the term “milkshake” is used to denote a, final, mixed and prepared product, which comprises water, a source of dairy (or a non-dairy substitute, as discussed below), and flavors where applicable. The term “pre-milkshake mixture” is used to refer to a mixture of water or ice, a dairy base (or a non-dairy substitute), and flavors where needed, before the final milkshake is mixed. The methods of the present disclosure are also applicable to other beverages, such as fruit shakes, cream flavor shakes, alcoholic shakes, shakes containing aggregate particulate (such as pieces of candy, cookies, confections, etc.) that possesses desirable physical and organoleptic properties similar to conventional milkshakes produced from ice cream and milk. The method (1) of the present disclosure comprises a cyclic operation (10), and pre-cycle steps (20) prior to operation (10).

During the cycle of operation (10), a cup or vessel is put in place in a machine (step 11). The user selects the flavor and size for the resulting milkshake (step 12), and initiates the blending process, for example by pushing “START” on a user interface of the machine (step 13). The machine dispenses ice (step 14), a dairy mix (step 15), and flavor (step 16) into the cup, to form the pre-milkshake mixture. The cup can then either be moved to a blending station or left in place (step 17), where the pre-milkshake mixture in the cup is blended (step 18) to produce the final milkshake (step 19).

Advantageously, there is only one step required of the user in cycle (10), beyond initiating the cycle (10). Namely, all the user has to do is select the desired flavor and size (step 12) of the milkshake. This presents a significant advantage over currently available systems, which require that ice cream be made and dispensed first, and then blended with additional dairy bases (or non-dairy substitutes), flavors, or ice. The method of the present disclosure thus eliminates the requirement for storing frozen product such as ice cream in a freezing apparatus. Operators preparing the milkshakes of the present disclosure do not need to mix multiple components together. All an operator needs to do is select (step 12) and initiate (step 13) the desired program, and the stored program prepares the milkshake. This eliminates variations in quality and feel introduced by user error. The milkshakes of the present disclosure, made according to the method described above, provide a consistent product with consistent organoleptic (e.g., mouth feel sensations such as creaminess, cold, and thickness) properties.

The dispensing of the ice (step 14), dairy base (step 15), and flavor (step 16) can occur in any order, not necessarily in the order shown. In some applications, it may be advantageous to dispense the ice (step 14) first, since it will anchor the cup in place, and reduce the risk of the cup getting knocked over during the process. The total amount of time of cycle (10) can be about ten seconds to about five minutes, from about one minute to about two minutes, or any subranges therebetween.

Prior to the preparation of the milkshake in operation (10), the method of the present disclosure can also have pre-cycle steps (20). In pre-operation (20), an algorithm, process, or program including desired mixes of ingredients and blending profiles (step 22) is stored on a controller of the machine (step 21). The dairy (or non-dairy) base mix, discussed in greater detail below, is loaded into machine (steps 23, 21), as is either water or ice (steps 24, 21). Liquid flavor syrup can either be hand dispensed or added to the machine (steps 25, 21) as well. In one embodiment, the user can be prompted as to whether the flavor is manually or automatically added (step 26). In one embodiment, the flavor syrup can be added manually by the user (step 16a) during the cycle of operation (10). The milkshake of the present disclosure could also be prepared independently of a machine . A user could prepare the milkshake according to directions that included ingredients, amounts, and mixing steps, but as discussed above, this may introduce variability to the finished product.

The present disclosure also provides a dairy base formulation that is adjustable to user needs or desires, and can meet desired organoleptic and dietary requirements. The dairy base formulation is used in conjunction with the method of preparation (1) described above, and saves on the cost and time associated with traditional milkshakes. It saves the user the cost of preparing a frozen ice cream product to work with, and eliminates process steps associated with adding syrup, milk, ice or other components to the ice cream. The dairy base formulation of the present disclosure is tailored to achieve characteristics typically desired in the foodservice industry, and is easy and convenient to use when preparing the milkshake. The dairy base formulation is capable of being processed into a milkshake beverage by blending with ice using a controllable cycle blending device, resulting in a milkshake that possesses desirable physical and organoleptic properties, similar to conventional milkshakes produced from ice cream and milk.

The dairy base formulation comprises: 1) at least one source of water; 2) at least one source of milk solids; 3) at least one source of concentrated milk fat or vegetable fat; 4) at least one source of freezing point depressant; 5) at least one source of sweetener; and 6) a mix of stabilizers and/or emulsifiers. The dairy base formulation may also optionally include 7) one or more shelf life stabilizers.

The source of water may be water, milk, or a combination thereof. The milk solids are typically dried instant milk or milk powder. The freezing point depressant may be sugar, modified starches, sugar alcohols, or any combinations thereof. The sweetener may be sugar, honey, rebiana, stevia, or any combinations thereof. Compounds that may act as either stabilizers and/or emulsifiers may be guar gum, xantam gum, carrageenan, methylcellulose, pectin, or any combinations thereof. These specific compounds are not exhaustive lists of the suitable candidates for the dairy base formulation of the present disclosure.

Alternatives to dairy milk could be used, for example soy or almond milk. Such alternatives would obviously affect the organoleptic properties of the dairy base and the finished milkshake, but could still be suitable in the milkshakes of the present disclosure. In some cases, where an alternative milk is used, a substitute for dairy milk proteins may be used, such as soy protein, alone or in conjunction with agar or carageenan. The term “dairy base formulation” as it is used in the present disclosure should be understood to comprise ingredients 1)-7) discussed above, with a non-dairy milk substitute, non-dairy milk solid substitute, or non-dairy milk fat substitute where desired.

In one embodiment, the amounts of the following components of the dairy base formulation can be as follows, each based on the total weight of the formulation. Any subranges of the cited ranges may also be used. The listed components can also be present in an amount of about the listed weight amounts.

| | % w/w | % w/w | % w/w |
|---|---|---|---|
| Component | 1st range | 2nd range | 3rd range |
| Water | 40.0-70.0% | 55.0-70.0% | 62.0-68.0% |
| Milk solids, non-fat | 15.0-20.0% | 15.0-20.0% | 15.0-20.0% |
| Fat | 5.0-10.0% | 6.0-9.0% | 6.5-8.0% |
| Stabilizers | 1.5-3.5% | 2.0-3.0% | 2.0-2.5% |
| Emulsifiers | 0.2-2.5% | 0.3-1.3% | 0.5-1.0% |

When used in the dairy base, sugar can be present in an amount of about 13.0%—about 37.0%, from about 18.0% to about 30.0%, or from about 22.0% to about 26.0%. Sugar can be present in milk solids, and can also function as a sweetener or freezing point depressant, as discussed above. Thus, in some cases, the sum of the listed items may not equal 100%, since some sugars are part of the sweeteners, freezing point depressants, and the milk solids.

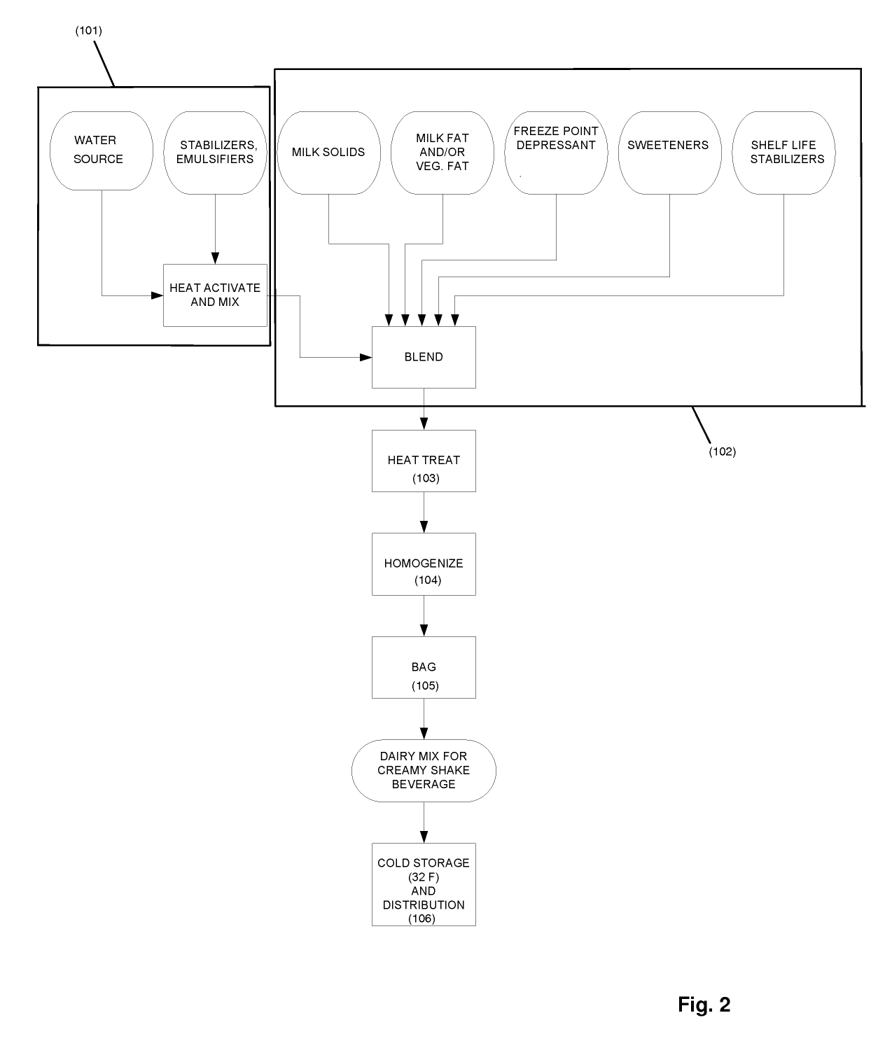

The dairy base formulation can also be prepared according to the following method, which is depicted in the flowchart of FIG. 2. First, in step (101) the stabilizer and/or emulsifier mix can be heat activated with the water source alone to form an emulsified suspension. Then, the remainder of the components from the formulation described above can be blended into the heat activated stabilizer and emulsifier suspension (step 102). As an optional step (103), the blended mix can be heat treated using standard ice cream heat treating equipment, which heats the mix to about 65 degrees Celsius or above, and then cools it down rapidly. Then the blend is homogenized (step 104) using a high energy homogenizer (e.g., under ultra high pressure, or a high shear homogenizing head), such as to produce fat droplets of a diameter not larger than ten microns. The blend can then be aseptically bagged (step 105), and refrigerated (step 106) for conservation and distribution.

In one embodiment, step (101) above comprises heating about 30% of the water source to about 75 degrees Celsius, adding the stabilizers, blending with an immersion blender for about 10 seconds to about 90 seconds, about 30 seconds to about 60 seconds, then adding the remainder of the water source, and blending with an immersion blender for about 30 to about 120 seconds, about 45 to about 90 seconds. Still within step (101) as described above, the emulsifiers can then be added, and the mix is further blended for about 30 to about 120 seconds, or about 45 to about 90 seconds. All time ranges include those times, and any subranges therebetween.

Before the aseptical bagging step (105) above, the mix can be pasteurized, for example at about 80 to about 95 degrees Celsius, about 85 to about 88 degrees Celsius, and then cooled to about four degrees Celsius.

To run method (1) of the present disclosure with the claimed dairy base, the machine can display a main menu to a user. As described above, the user selects the desired drink and size (step 12) from icons or buttons displayed on the machine. The user then places the cup or vessel under a dispenser, and selects start (step 13) to dispense the product and ice. A screen on the machine can give a visual indication that dispensing is taking place. After dispensing is done, the user moves the cup to a blending chamber (step 17), and activates the blending operation, which in one embodiment can be within the cup or vessel itself. Advantageously, the method (1) of the present disclosure can be set up on a machine so that while one milkshake is blending, the ingredients for another can be dispensed. The machine can give a visual indication when the blending operation is complete. Once the completed milkshake is removed, the machine can initiate a sanitation and rinse feature in the blending area.

When running method (1) of the present disclosure, the proportions of dairy base, ice, and flavor can be, for example, as follows, based on the total weight of the prepared milkshake. Any subranges of the cited ranges may also be used. The listed components can also be present in an amount of about the listed weight amounts.

| Component | % w/w |
|---|---|
| Dairy Base Formulation | 40.0-60.0% |
| Ice | 30.0-50.0% |
| Flavor (e.g., strawberry) | 5.0-15.0% |

The organoleptic properties of the prepared milkshake can be varied by modifying the blending profile in method (1). With variations of the speed of a mixing spindle, many types of creamy and well aerated milkshake beverages can be produced. These include, but are not limited to, fruit shakes, cream flavor shakes, alcoholic shakes, shakes containing aggregate particulate (such as pieces of candy, cookies, confections, etc.) that possesses desirable physical and organoleptic properties similar to conventional milkshakes produced from ice cream and milk.

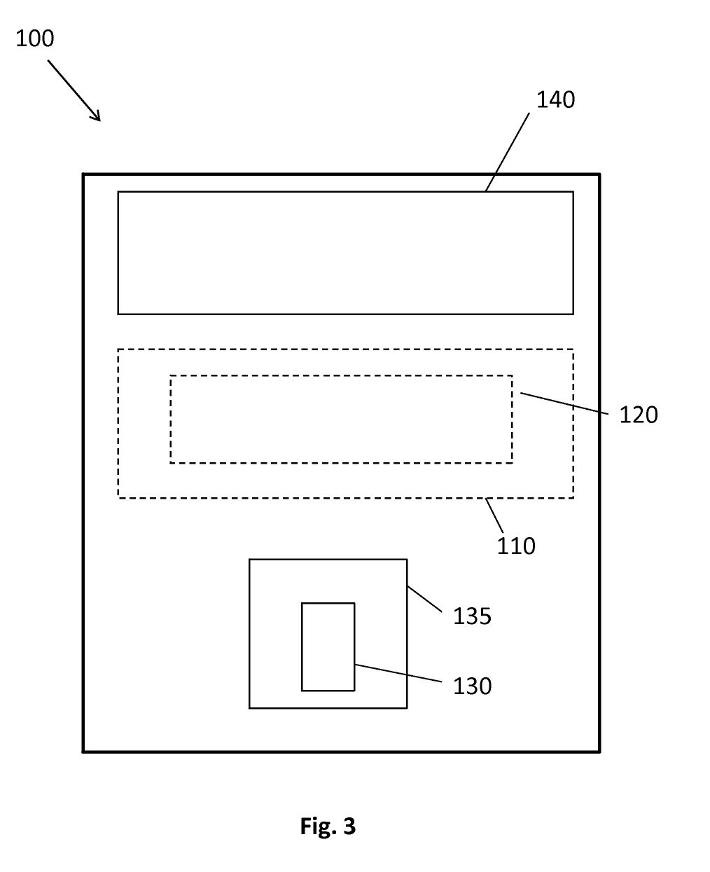

Referring to FIG. 3, a machine 100 that can be used in the present disclosure is shown. Machine 100 has a controller 110 with an algorithm, recipe, or program (collectively “algorithm”) 120 resident thereon. Algorithm 120 can have information relating to the methods (e.g., recipes and mixing steps) of the present disclosure described above. Controller 110 controls machine 100 to perform the steps. A vessel 130 to store the ingredients can be placed in a dispensing area 135 adjacent to or within a recessed cavity within machine 100. The ingredients in the prepared milkshake can also be blended or mixed within dispensing area 135, or at a separate blending/mixing station. Machine 100 can also have a user interface 140 on a face thereof. As described above, the user can select the type of milkshake they wish to be prepared by selecting a program or option in interface 140.

The dairy base formulation and method of preparing a milkshake (1) described earlier in this application can be performed on any machine capable of storing, dispensing, and mixing the components as described. For example, one such machine is shown and described in U.S. Pat. No. 8,459,176, and its related applications, which are incorporated herein by reference. In one embodiment, the milkshake of the present disclosure can be prepared with a Manitowoc Multiplex blend-in-cup (BIC) machine. Also, the following blend profile can be used for a 12 oz cup capacity: 100% blade speed, 10% spindle speed, four second dwell at the bottom of the cup, 1.8 inches mix in the middle of the cup, 4 seconds dwell in the middle of the cup, and 4 repeats.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

1. A method of preparing a milkshake, comprising the steps of:
adding ice, a dairy base formulation, and a flavoring to a vessel, thereby forming a pre-milkshake mixture; and
blending said pre-milkshake mixture, thereby forming the milkshake.

2. The method of claim 1, wherein said ice is dispensed into said vessel before said liquid dairy base and said flavoring.

3. The method of claim 1, wherein said dairy base formulation comprises:
water;
a milk solid, a milk solid substitute, or a combination thereof;
at least one of milk fat, non-dairy milk substitute fat, and vegetable fat; and
at least one additive selected from the group consisting or a freezing point depressant, a sweetener, a mix of stabilizers and/or emulsifiers, and a shelf life stabilizer.

4. The method of claim 3, wherein said water is derived from milk.

5. The method of claim 3, wherein said freezing point depressant is present and selected from the group consisting of sugar, modified starches, sugar alcohols, and any combinations thereof.

6. The method of claim 3, wherein said sweetener is present and selected from the group consisting of sugar, honey, rebiana, stevia, and any combinations thereof.

7. The method of claim 3, wherein mix of stabilizers and/or emulsifiers is present, and includes at least one compound selected form the group consisting of guar gum, xantam gum, carrageenan, methylcellulose, pectin.

8. The method of claim 3, wherein said water is present in an amount of about 40 wt % to about 70 wt %, based on the total weight of said dairy base.

9. The method of claim 3, wherein said milk solid is present in an amount of about 15 wt % to about 20 wt %, based on the total weight of said dairy base.

10. The method of claim 3, wherein said milk or vegetable fat is present in an amount of about 5 wt % to about 10 wt %, based on the total weight of said dairy base.

11. The method of claim 3, wherein said stabilizer is present in an amount of about 1.5 wt % to about 3.5 wt %, based on the total weight of said dairy base.

12. The method of claim 3, wherein said emulsifier is present in an amount of about 0.2 wt % to about 2.5 wt %, based on the total weight of said dairy base.

13. The method of claim 3, wherein said freezing point depressant and/or sweetener is sugar, present in an amount of about 13.0 wt % to about 37.0 wt %, based on the total weight of said dairy base.

14. The method of claim 1, wherein said ice, said liquid dairy base, and said flavoring are added to said vessel according to an algorithm resident on a controller of a machine.

15. The method of claim 14, wherein said algorithm on said controller further controls said machine to perform said blending step.

16. A dairy base formulation, comprising:
water;
a milk solid, a milk solid substitute, or a combination thereof;
at least one of milk fat, non-dairy milk substitute fat, and vegetable fat; and
at least one additive selected from the group consisting or a freezing point depressant, a sweetener, a mix of stabilizers and/or emulsifiers, and a shelf life stabilizer.

17. The dairy base formulation of claim 16, wherein said water is derived from milk.

18. The dairy base formulation of claim 16, wherein said freezing point depressant is present and selected from the group consisting of sugar, modified starches, sugar alcohols, and any combinations thereof.

19. The dairy base formulation of claim 16, wherein said sweetener is present and selected from the group consisting of sugar, honey, rebiana, stevia, and any combinations thereof.

20. The dairy base formulation of claim 16, wherein said mix of stabilizers and/or emulsifiers is present, and includes at least one compound selected form the group consisting of guar gum, xantam gum, carrageenan, methylcellulose, pectin.

21. The dairy base formulation of claim 16, wherein said water is present in an amount of about 40 wt % to about 70 wt %, based on the total weight of the formulation.

22. The dairy base formulation of claim 16, wherein said milk solid is present in an amount of about 15 wt % to about 20 wt %, based on the total weight of the formulation.

23. The dairy base formulation of claim 16, wherein said milk or vegetable fat is present in an amount of about 5 wt % to about 10 wt %, based on the total weight of the formulation.

24. The dairy base formulation of claim 16, wherein said stabilizer is present in an amount of about 1.5 wt % to about 3.5 wt %, based on the total weight of the formulation.

25. The dairy base formulation of claim 16, wherein said emulsifier is present in an amount of about 0.2 wt % to about 2.5 wt %, based on the total weight of the formulation.

26. The dairy base formulation of claim 16, wherein said freezing point depressant and/ or sweetener is sugar, present in an amount of about 13.0 wt % to about 37.0 wt %, based on the total weight of the formulation.
